(19) United States
(12) Patent Application Publication
(10) Pub. No.: US 2021/0118361 A1
(43) Pub. Date: Apr. 22, 2021

(54) AMOLED PIXEL DRIVING CIRCUIT, DRIVING METHOD, AND DISPLAY PANEL

(71) Applicant: Wuhan China Star Optoelectronics Semiconductor Display Technology Co., Ltd., Wuhan (CN)

(72) Inventor: Jun Li, Wuhan (CN)

(21) Appl. No.: 16/319,823

(22) PCT Filed: Sep. 26, 2018
(86) PCT No.: PCT/CN2018/107765

§ 371 Date: Jan. 23, 2019

(30) Foreign Application Priority Data
Aug. 20, 2018 (CN) 201810950702.4

(51) Int. Cl. G09G 3/3233

(52) U.S. Cl. CPC G09G 3/3233; G09G 2320/0233; G09G 2310/08; G09G 2300/0819

(57) ABSTRACT

The present invention teaches an AMOLED pixel driving circuit, its driving method, and a display panel. The AMOLED pixel driving circuit adopts a 7T1C structure and provides a reset stage, a data signal entry and threshold voltage compensation stage, and a lighting stage. The AMOLED pixel driving circuit is able to compensate the threshold voltage shift of the first TFT, also the driving TFT, and, to cut off a path prone to leakage during the lighting stage between the fourth TFT and the gate of the first TFT, also the driving TFT, by the second TFT, thereby reducing the gate voltage shift at the driving TFT and enhancing the display quality of the AMOLED display panel.

### FIELD OF THE INVENTION

The present invention is generally related to the field of display technology, and more particularly to an AMOLED pixel driving circuit, its driving method, and a display panel.

### BACKGROUND OF THE INVENTION

Organic light emitting diode (OLED) display device is deemed as the most promising display device by the industry due to its self-illumination, low driving voltage, high lighting efficiency, short response time, enhanced clarity and contrast, nearly 180-degree viewing angle, wide operation temperature range, and the capability to fulfill flexible, large-dimension, full-color display.

According to its driver mechanism, an OLED display device may be categorized as a passive matrix OLED (PMOLED) display device using direct addressing or an active matrix OLED (AMOLED) display device using thin film transistor (TFT) addressing.

AMOLED involves pixels in an array, each driven by an OLED pixel driving circuit.

As shown in FIG. 1, a conventional AMOLED pixel driving circuit has a 2T1C structure including a switch TFT T100, a driving TFT T200, and a storage capacitor C100. The switch TFT T100 and the driving TFT T200 are both N-type TFT. The driving TFT T200 controls a driving current to an OLED D100. The driving current follows the following equation:

I_{OLED}=K×(V_{gs}−Vₜₕ)²

I_{OLED} is the driving current, K is the current amplification factor of the driving TFT T200 which is determined by T200's electrical characteristics, V_{gs} is the voltage difference between T200's gate and source, and Vₜₕ is T200's threshold voltage. Therefore, the driving current I_{OLED} is related to the threshold voltage of the driving TFT T200.

As the threshold voltage of the driving TFT T200 is easy to drift, causing variation in the driving current I_{OLED} and therefore uneven brightness and inferior display quality in the AMOLED display panel.

To resolve this problem, display manufacturers have provided various pixel driving circuits that may compensate the threshold voltage of the driving TFT.

However, existing AMOLED pixel driving circuits capable of compensating driving TFT's threshold voltage still suffer an obvious shortcoming. During a reset stage, a TFT for resetting the driving TFT has its source and drain respectively electrically connected to the gate of the driving TFT and a low level. To prevent drift occurring at the driving TFT's gate during a lighting stage, the leakage current from the TFT for resetting the driving TFT's gate voltage during the reset stage must be rather small. However, this is difficult to achieve as the TFT has a rather large voltage difference between the source and the drain. Then, the leakage would cause the driving TFT's gate voltage shift, compromising the AMOLED display quality.

### SUMMARY OF THE INVENTION

An objective of the present invention is to teach an AMOLED pixel driving circuit capable of not only compensating the driving TFT's threshold voltage drift, but also enhancing AMOLED display quality by reducing the driving TFT's gate voltage shift resulted from leakage during the lighting stage.

Another objective of the present invention is to teach an AMOLED pixel driving method capable of not only compensating the driving TFT's threshold voltage drift, but also enhancing AMOLED display quality by reducing the driving TFT's gate voltage shift resulted from leakage during the lighting stage.

Yet another objective of the present invention is to teach a display panel whose pixel driving circuit is capable of not only compensating the driving TFT's threshold voltage drift, but also enhancing display quality by reducing the driving TFT's gate voltage shift resulted from leakage during the lighting stage.

To achieve the objectives, the present invention teaches an AMOLED pixel driving circuit, including a first TFT, a second TFT, a third TFT, a fourth TFT, a fifth TFT, a sixth TFT, a seventh TFT, a storage capacitor, and an OLED, wherein the first TFT is a driving TFT;

the first TFT has its gate electrically connected to a second junction, its source electrically connected to a first junction, and its drain electrically connected to a third junction;

the second TFT has its gate applied with a first control signal, its source electrically connected to the second junction, and its drain electrically connected to the third junction;

the third TFT has its gate applied with a third control signal, its source applied with a data signal, and its drain electrically connected to the first junction;

the fourth TFT has its gate applied with a second control signal, its source applied with a low voltage, and its drain electrically connected to the third junction;

the fifth TFT has its gate applied with a lighting control signal, its source electrically connected to the third junction, and its drain electrically connected to a fourth junction;

the seventh TFT has its gate applied with the third control signal, its source applied with the low voltage, and its drain electrically connected to the fourth junction;

the storage capacitor has a terminal applied with a positive power voltage and another terminal electrically connected to the second junction;

the OLED has its anode electrically connected to the fourth junction and its cathode applied with a negative power voltage;

the AMOLED pixel driving circuit operates in a reset stage, a data signal entry and threshold voltage compensation stage, and a lighting stage;

during the reset stage of the AMOLED pixel driving circuit, the second TFT and fourth TFT are turned on, and the third TFT, fifth TFT, sixth TFT, and seventh TFT are turned off; during the data signal entry and threshold voltage compensation stage of the AMOLED pixel driving circuit, the second TFT, third TFT, and seventh TFT are turned on, and the fourth TFT, fifth TFT, and sixth TFT are turned off; and, during the lighting stage of the AMOLED pixel driving circuit, the fifth TFT and sixth TFT are turned on, and the second TFT, third TFT, fourth TFT, and seventh TFT are turned off.

The first TFT, second TFT, third TFT, fourth TFT, fifth TFT, sixth TFT, and seventh TFT are all P-type TFTs.

During the reset stage, the first and second control signals are at low level, and the third control signal and lighting control signal are at high level; during the data signal entry and threshold voltage compensation stage, the first and third control signals are at low level, and the second control signal and lighting control signal are at high level; and, during the lighting stage, the lighting control signal is at low level, and the first, second, and third control signals are at high level.

The first control signal, second control signal, third control signal, and lighting control signal are all generated by an external timing controller.

Each of the first TFT, second TFT, third TFT, fourth TFT, fifth TFT, sixth TFT, and seventh TFT is a low temperature poly-silicon TFT, an oxide semiconductor TFT, or an amorphous silicon TFT.

The present invention also teaches an AMOLED pixel driving circuit method for driving the above described AMOLED pixel driving circuit. The driving method includes the following steps:

Step S1: setting the AMOLED pixel driving circuit in a reset stage, where

the second TFT and fourth TFT are turned on, the third TFT, fifth TFT, sixth TFT, and seventh TFT are turned off, and the first TFT has its gate reset to a low voltage;

Step S2: setting the AMOLED pixel driving circuit in a data signal entry and threshold voltage compensation stage, where

the second TFT, third TFT, and seventh TFT are turned on, and the fourth TFT, fifth TFT, and sixth TFT are turned off, the first TFT has its gate and drain short-circuited together and functions as a diode, the data signal is written into the source of the first TFT T1, and the gate of the first TFT is charged; and

in the meantime, the anode of the OLED is reset to the low voltage; and

Step S3: setting the AMOLED pixel driving circuit in a lighting stage, where

the fifth TFT and sixth TFT are turned on, and the second TFT, third TFT, fourth TFT, and seventh TFT are turned off, the second TFT cuts off a path between the fourth TFT and the gate of the first TFT, and

a driving current drives the OLED to illuminate as the driving current flows through the OLED, and the driving current is not related by a threshold voltage of the driving TFT.

The first TFT, second TFT, third TFT, fourth TFT, fifth TFT, sixth TFT, and seventh TFT are all P-type TFTs.

In step S1, the first and second control signals are at low level, and the third control signal and lighting control signal are at high level; in step S2, the first and third control signals are at low level, and the second control signal and lighting control signal are at high level; and, in step S3, the lighting control signal is at low level, and the first, second, and third control signals are at high level.

The first control signal, second control signal, third control signal, and lighting control signal are all generated by an external timing controller.

Each of the first TFT, second TFT, third TFT, fourth TFT, fifth TFT, sixth TFT, and seventh TFT is a low temperature poly-silicon TFT, an oxide semiconductor TFT, or an amorphous silicon TFT.

The present invention also teaches a display panel including the above described AMOLED pixel driving circuit.

The advantages of the present invention are as follows. The AMOLED pixel driving circuit of the present invention adopts a 7T1C structure and provides a reset stage, a data signal entry and threshold voltage compensation stage, and a lighting stage. The AMOLED pixel driving circuit is able to compensate the threshold voltage shift of the first TFT, also the driving TFT, and, to cut off a path prone to leakage during the lighting stage between the fourth TFT and the gate of the first TFT, also the driving TFT, by the second TFT, thereby reducing the gate voltage shift at the driving TFT and enhancing the display quality of the display panel. The AMOLED pixel driving method of the present invention is for driving the AMOLED pixel driving circuit. The driving method is able to compensate the driving TFT's threshold voltage shift, and to reduce the driving TFT's gate voltage shift resulted from leakage during the lighting stage, thereby providing a better display quality. The display panel of the present invention includes the above described AMOLED pixel driving circuit. The display panel therefore is able to compensate the driving TFT's threshold voltage shift, and to reduce the driving TFT's gate voltage shift resulted from leakage during the lighting stage, thereby providing a better display quality.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a circuit diagram of a conventional 2T1C-structure AMOLED pixel driving circuit.

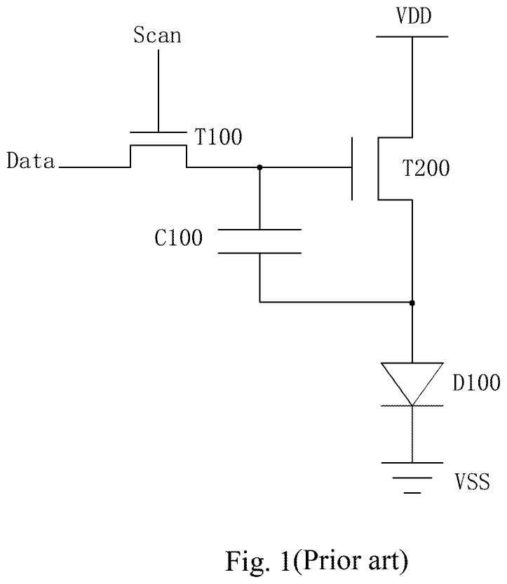

FIG. 2 is a circuit diagram showing an AMOLED pixel driving circuit of the present invention.

FIG. 3 is a timing diagram of the AMOLED pixel driving circuit of FIG. 2.

FIG. 4 is a schematic diagram showing the step S1 of an AMOLED pixel driving method of the present invention.

FIG. 5 is a schematic diagram showing the step S2 of an AMOLED pixel driving method of the present invention.

FIG. 6 is a schematic diagram showing the step S3 of an AMOLED pixel driving method of the present invention.

### DETAILED DESCRIPTION OF PREFERRED EMBODIMENTS

The following descriptions for the respective embodiments are specific embodiments capable of being implemented for illustrations of the present invention with referring to appended figures.

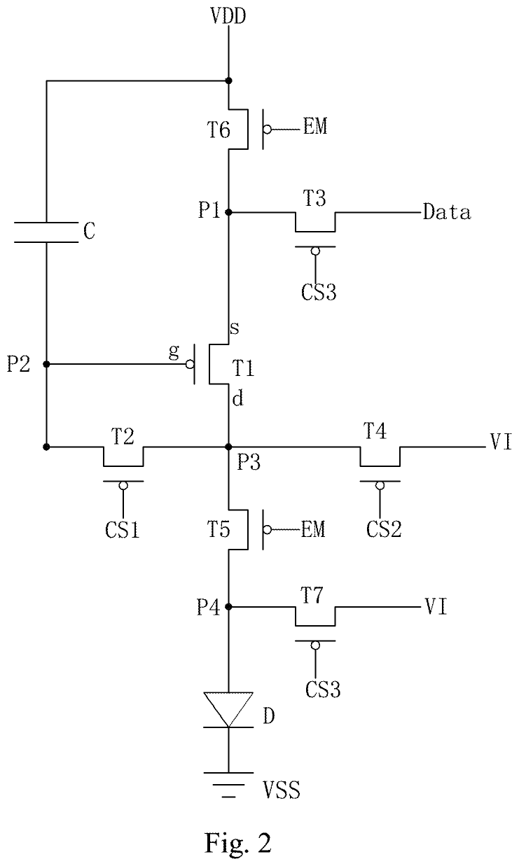

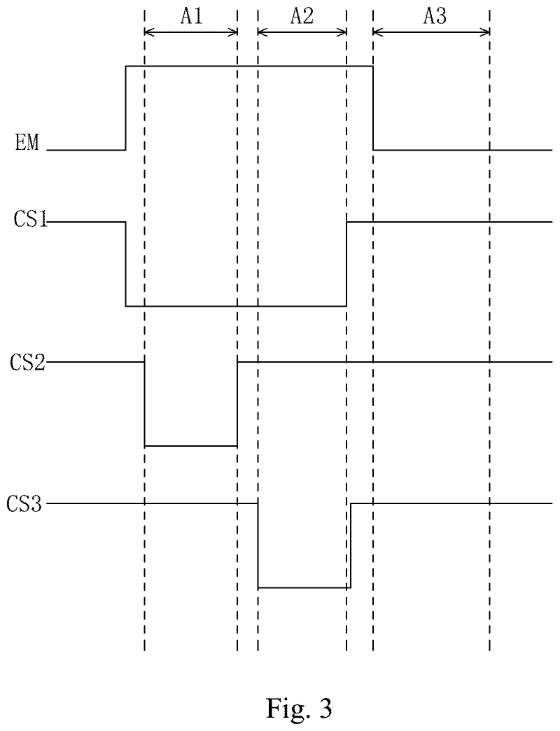

As shown in FIGS. 2 and 3, the present invention teaches an AMOLED pixel driving circuit having a 7T1C structure and including a first TFT T1, a second TFT T2, a third TFT T3, a fourth TFT T4, a fifth TFT T5, a sixth TFT T6, a seventh TFT T7, a storage capacitor C, and an OLED D. The first TFT T1 is the driving TFT.

The first TFT T1 has its gate (g) electrically connected to a second junction P2, its source (s) electrically connected to a first junction P1, and its drain (d) electrically connected to a third junction P3.

The second TFT T2 has its gate applied with a first control signal CS1, its source electrically connected to the second junction P2, and its drain electrically connected to the third junction P3.

The third TFT T3 has its gate applied with a third control signal CS3, its source applied with a data signal Data, its drain electrically connected to the first junction P1.

The fourth TFT T4 has its gate applied with a second control signal CS2, its source applied with a low voltage VI, and its drain electrically connected to the third junction P3.

The fifth TFT T5 has its gate applied with a lighting control signal EM, its source electrically connected to the third junction P3, and its drain electrically connected to a fourth junction P4.

The seventh TFT T7 has its gate applied with the third control signal CS3, its source applied with the low voltage VI, and its drain electrically connected to the fourth junction P4.

The storage capacitor (C) has a terminal applied with a positive power voltage VDD and another terminal electrically connected to the second junction P2.

The OLED (D) has its anode electrically connected to the fourth junction P4 and its cathode applied with a negative power voltage VSS.

Specifically, each of the first TFT T1, second TFT T2, third TFT T3, fourth TFT T4, fifth TFT T5, sixth TFT T6, and seventh TFT T7 is a low temperature poly-silicon TFT, an oxide semiconductor TFT, or an amorphous silicon TFT.

The first control signal CS1, second control signal CS2, third control signal CS3, and lighting control signal EM are all generated by an external timing controller. The first control signal CS1 turns on or off the second TFT T2, the second control signal CS2 turns on or off the fourth TFT T4, the third control signal CS3 turns on or off the third TFT T3 and seventh TFT T7, and the lighting control signal EM turns on or off the sixth TFT T6 and fifth TFT T5.

As shown in FIG. 3, the AMOLED pixel driving circuit operates in a reset stage A1, a data signal entry and threshold voltage compensation stage A2, and a lighting stage A3.

Together with FIG. 2, the first TFT T1, second TFT T2, third TFT T3, fourth TFT T4, fifth TFT T5, sixth TFT T6, and seventh TFT T7 are all P-type TFTs.

During the reset stage A1, the first control signal CS1 is at low level and the second TFT T2 is turned on; the second control signal CS2 is at low level and the fourth TFT T4 is turned on; the third control signal CS3 is at high level and the third TFT T3 and seventh TFT T7 are turned off; and the lighting control signal EM is at high level and the sixth TFT T6 and fifth TFT T5 are turned off.

The first TFT T1 has its gate (g) reset to the low voltage VI through the series-connected and turned-on second TFT T2 and fourth TFT T4.

During the data signal entry and threshold voltage compensation stage A2, the first control signal CS1 remains at low level and the second TFT T2 is turned on; the second control signal CS2 changes to high level and the fourth TFT T4 is turned off; the third control signal CS3 is at low level and the third TFT T3 and seventh TFT T7 are turned on; and the lighting control signal EM is at high level and the sixth TFT T6 and fifth TFT T5 are turned off.

The first TFT T1 has its gate (g) and drain (d) short-circuited together through the turned-on second TFT T2 and functions like a diode; the data signal Data is written into the source (s) of the first TFT T1 through the turned-on third TFT T3. Through the diode function of the first TFT T1, the gate (g) of the first TFT T1 is charged to

V_{g}=V_{data}−|Vₜₕ|

V_{g} is the voltage at the gate (g) of the first TFT T1, V_{data} is data signal Data's voltage, and Vₜₕ is the threshold voltage of the first TFT T1.

In the meantime, the anode of the OLED (D) is reset to the low voltage VI through the turned-on seventh TFT T7.

During the lighting A3, the first control signal CS1 changes to high level and the second TFT T2 is turned off; the second control signal CS2 remains at high level and the fourth TFT T4 is turned off; the third control signal CS3 is at high level and the third TFT T3 and seventh TFT T7 are turned off; and the lighting control signal EM changes to low level and the sixth TFT T6 and fifth TFT T5 are turned on.

As the sixth TFT T6 is turned on, the source (s) of the first TFT T1 has the positive power voltage VDD. The driving current drives the OLED (D) to illuminate as the driving current flows through the turned-on fifth TFT T5 towards the OLED (D). The driving current follows the following equation:

I_{OLED}=K×(Vₛ−V_{g}−|Vₜₕ|²=K×(VDD−(V_{data}−|Vₜₕ|)−|Vₜₕ|)²=K×(VDD−V_{data})²

I_{OLED} is the driving current, K is the current amplification factor of the first TFT T1, also the driving TFT, which is determined by T1's electrical characteristics, Vₛ is the voltage at T1's source, and VDD is the positive power voltage.

Therefore, the driving current I_{OLED} has nothing to do with the threshold voltage Vₜₕ of the first TFT T1, also the driving TFT, and the AMOLED pixel driving circuit of the present invention is able to compensate the threshold voltage drift of the driving TFT.

It should be noted that, in the AMOLED pixel driving circuit of the present invention, the fourth TFT T4, where the low voltage VI is applied, is series-connected to the second TFT T2. The second TFT T2 is then connected to the gate (g) of the first TFT T1 which is also the driving TFT. Then, during the light stage of A3, a path that is prone to leakage between the fourth TFT T4 and the gate (g) of the first TFT T1, also the driving TFT, is cut off by the turned-off second TFT T2. This significantly reduces the driving TFT gate voltage shift due to leakage in the lighting stage A3, thereby enhancing the AMOLED display quality.

The present invention also teaches an AMOLED pixel driving circuit method for driving the above described AMOLED pixel driving circuit. The driving method includes the following steps:

Step S1 sets the AMOLED pixel driving circuit in the reset stage A1.

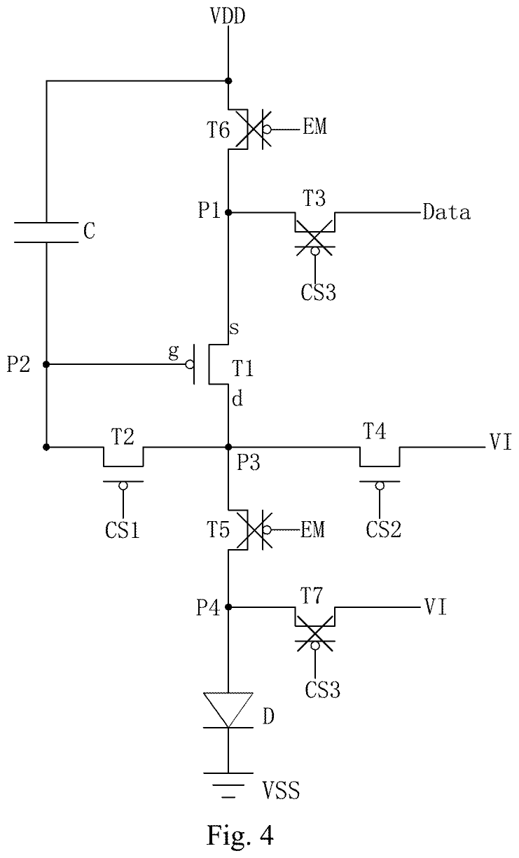

As shown in FIGS. 3 and 4, the first control signal CS1 and second control signal CS2 are at low level, and the third control signal CS3 and lighting control signal EM are at high level. The second TFT T2 and fourth TFT T4 are turned on, and the third TFT T3, fifth TFT T5, sixth TFT T6, and seventh TFT T7 are turned off.

The first TFT T1 has its gate (g) reset to the low voltage VI through the series-connected and turned-on second TFT T2 and fourth TFT T4.

Step S2 sets the AMOLED pixel driving circuit in the data signal entry and threshold voltage compensation stage A2.

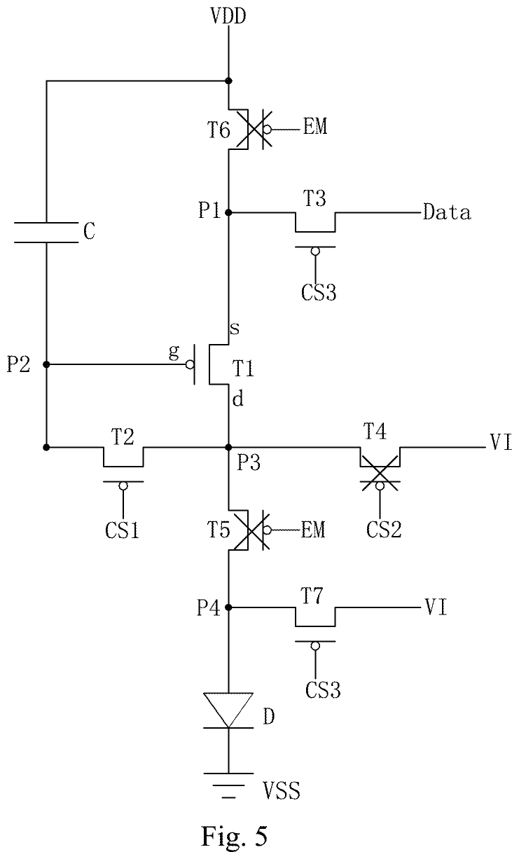

As shown in FIGS. 3 and 5, the first control signal CS1 and third control signal CS3 are at low level, and the second control signal CS2 and lighting control signal EM are at high level. The second TFT T2, third TFT T3, and seventh TFT T7 are turned on. The fourth TFT T4, fifth TFT T5, and sixth TFT T6 are turned off. The first TFT T1 has its gate (g) and drain (d) short-circuited together and functions like a diode.

The data signal Data is written into the source (s) of the first TFT T1 through the turned-on third TFT T3. Through the diode function of the first TFT T1, the gate (g) of the first TFT T1 is charged to

V_{g}=V_{data}−|Vₜₕ|

V_{g} is the voltage at the gate (g) of the first TFT T1, V_{data} is data signal Data's voltage, and Vₜₕ is the threshold voltage of the first TFT T1.

In the meantime, the anode of the OLED (D) is reset to the low voltage VI through the turned-on seventh TFT T7.

Step S3 sets the AMOLED pixel driving circuit in the lighting stage A3.

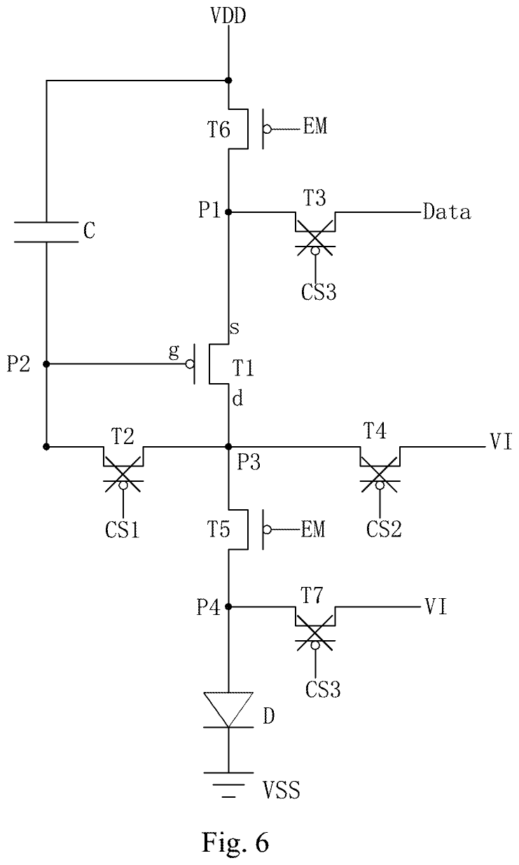

As shown in FIGS. 3 and 6, the lighting control signal EM is at low level, and the first control signal CS1, second control signal CS2, and third control signal CS3 are at high level. The fifth TFT T5 and sixth TFT T6 are turned on, and the second TFT T2, third TFT T3, fourth TFT T4, and seventh TFT T7 are turned off.

The source (s) of the first TFT T1 has the positive power voltage VDD. The driving current drives the OLED (D) to illuminate as the driving current flows towards the OLED (D). The driving current follows the following equation:

I_{OLED}=K×(Vₛ−V_{g}−|Vₜₕ|)^{2=K×(VDD-(V}_{data}−|Vₜₕ|)−|Vₜₕ|)²=K×(VDD−V_{data})²

I_{OLED} is the driving current, K is the current amplification factor of the first TFT T1, also the driving TFT, which is determined by T1's electrical characteristics, Vₛ is the voltage at T1's source, and VDD is the positive power voltage.

Therefore, the driving current I_{OLED} has nothing to do with the threshold voltage Vₜₕ of the first TFT T1, also the driving TFT, and the AMOLED pixel driving method of the present invention is able to compensate the threshold voltage drift of the driving TFT.

It should be noted that, in the AMOLED pixel driving method of the present invention, a path that is prone to leakage between the fourth TFT T4 and the gate (g) of the first TFT T1, also the driving TFT, is cut off by the turned-off second TFT T2. This significantly reduces the driving TFT gate voltage shift due to leakage in the lighting stage A3, thereby enhancing the AMOLED display quality.

The present invention also teaches a display panel. The display panel may be, but not limited to, an OLED display panel. The display panel includes an AMOLED pixel driving circuit shown in FIGS. 2 and 3. As the AMOLED pixel driving circuit is able to compensate the driving TFT's threshold voltage shift, and to reduce the driving TFT's gate voltage shift resulted from leakage during the lighting stage, the display panel of the present invention has a better display quality.

As described above, the AMOLED pixel driving circuit of the present invention adopts a 7T1C structure and provides a reset stage, a data signal entry and threshold voltage compensation stage, and a lighting stage. The AMOLED pixel driving circuit is able to compensate the threshold voltage shift of the first TFT, also the driving TFT, and, to cut off a path prone to leakage during the lighting stage between the fourth TFT and the gate of the first TFT, also the driving TFT, by the second TFT, thereby reducing the gate voltage shift at the driving TFT and enhancing the display quality of the display panel. The AMOLED pixel driving method of the present invention is for driving the AMOLED pixel driving circuit. The driving method is able to compensate the driving TFT's threshold voltage shift, and to reduce the driving TFT's gate voltage shift resulted from leakage during the lighting stage, thereby providing a better display quality. The display panel of the present invention includes the above described AMOLED pixel driving circuit. The display panel therefore is able to compensate the driving TFT's threshold voltage shift, and to reduce the driving TFT's gate voltage shift resulted from leakage during the lighting stage, thereby providing a better display quality.

Above are embodiments of the present invention, which does not limit the scope of the present invention. Any equivalent amendments within the spirit and principles of the embodiment described above should be covered by the protected scope of the invention.

What is claimed is:

1. An active matrix organic light emitting diode (AMOLED) pixel driving circuit, comprising a first thin film transistor (TFT), a second TFT, a third TFT, a fourth TFT, a fifth TFT, a sixth TFT, a seventh TFT, a storage capacitor, and an OLED (organic light emitting diode), wherein the first TFT is a driving TFT;
the first TFT has its gate electrically connected to a second junction, its source electrically connected to a first junction, and its drain electrically connected to a third junction;
the second TFT has its gate applied with a first control signal, its source electrically connected to the second junction, and its drain electrically connected to the third junction;
the third TFT has its gate applied with a third control signal, its source applied with a data signal, and its drain electrically connected to the first junction;
the fourth TFT has its gate applied with a second control signal, its source applied with a low voltage, and its drain electrically connected to the third junction;
the fifth TFT has its gate applied with a lighting control signal, its source electrically connected to the third junction, and its drain electrically connected to a fourth junction;
the seventh TFT has its gate applied with the third control signal, its source applied with the low voltage, and its drain electrically connected to the fourth junction;
the storage capacitor has a terminal applied with a positive power voltage and another terminal electrically connected to the second junction;
the OLED has its anode electrically connected to the fourth junction and its cathode applied with a negative power voltage;
the AMOLED pixel driving circuit operates in a reset stage, a data signal entry and threshold voltage compensation stage, and a lighting stage;
during the reset stage of the AMOLED pixel driving circuit, the second TFT and fourth TFT are turned on, and the third TFT, fifth TFT, sixth TFT, and seventh TFT are turned off; during the data signal entry and threshold voltage compensation stage of the AMOLED pixel driving circuit, the second TFT, third TFT, and seventh TFT are turned on, and the fourth TFT, fifth TFT, and sixth TFT are turned off; and, during the lighting stage of the AMOLED pixel driving circuit, the fifth TFT and sixth TFT are turned on, and the second TFT, third TFT, fourth TFT, and seventh TFT are turned off.

2. The AMOLED pixel driving circuit according to claim 1, wherein the first TFT, second TFT, third TFT, fourth TFT, fifth TFT, sixth TFT, and seventh TFT are all P-type TFTs;
During the reset stage, the first and second control signals are at low level, and the third control signal and lighting control signal are at high level; during the data signal entry and threshold voltage compensation stage, the first and third control signals are at low level, and the second control signal and lighting control signal are at high level; and, during the lighting stage, the lighting control signal is at low level, and the first, second, and third control signals are at high level.

3. The AMOLED pixel driving circuit according to claim 2, wherein the first control signal, second control signal, third control signal, and lighting control signal are all generated by an external timing controller.

4. The AMOLED pixel driving circuit according to claim 1, wherein each of the first TFT, second TFT, third TFT, fourth TFT, fifth TFT, sixth TFT, and seventh TFT is a low temperature poly-silicon TFT, an oxide semiconductor TFT, or an amorphous silicon TFT.

5. An AMOLED pixel driving method for an AMOLED pixel driving circuit as claimed in claim 1, comprising
step S1: setting the AMOLED pixel driving circuit in a reset stage, where
the second TFT and fourth TFT are turned on, the third TFT, fifth TFT, sixth TFT, and seventh TFT are turned off, and the first TFT has its gate reset to a low voltage;
step S2: setting the AMOLED pixel driving circuit in a data signal entry and threshold voltage compensation stage, where
the second TFT, third TFT, and seventh TFT are turned on, and the fourth TFT, fifth TFT, and sixth TFT are turned off, the first TFT has its gate and drain short-circuited together and functions as a diode, the data signal is written into the source of the first TFT T1, and the gate of the first TFT is charged; and
in the meantime, the anode of the OLED is reset to the low voltage; and
step S3: setting the AMOLED pixel driving circuit in a lighting stage, where
the fifth TFT and sixth TFT are turned on, and the second TFT, third TFT, fourth TFT, and seventh TFT are turned off, the second TFT cuts off a path between the fourth TFT and the gate of the first TFT, and
a driving current drives the OLED to illuminate as the driving current flows through the OLED, and the driving current is not related by a threshold voltage of the driving TFT.

6. The AMOLED pixel driving method according to claim 5, wherein the first TFT, second TFT, third TFT, fourth TFT, fifth TFT, sixth TFT, and seventh TFT are all P-type TFTs;
in step S1, the first and second control signals are at low level, and the third control signal and lighting control signal are at high level; in step S2, the first and third control signals are at low level, and the second control signal and lighting control signal are at high level; and, in step S3, the lighting control signal is at low level, and the first, second, and third control signals are at high level.

7. The AMOLED pixel driving method according to claim 6, wherein the first control signal, second control signal, third control signal, and lighting control signal are all generated by an external timing controller.

8. The AMOLED pixel driving method according to claim 5, wherein each of the first TFT, second TFT, third TFT, fourth TFT, fifth TFT, sixth TFT, and seventh TFT is a low temperature poly-silicon TFT, an oxide semiconductor TFT, or an amorphous silicon TFT.

9. A display panel comprising an AMOLED pixel driving circuit as claimed in claim 1.
